(19) United States
(12) Patent Application Publication
(10) Pub. No.: US 2025/0192379 A1
(43) Pub. Date: Jun. 12, 2025

(54) TRACTION BATTERY PACK TERMINAL GUIDE

(71) Applicant: Ford Global Technologies, LLC, Dearborn, MI (US)

(72) Inventor: Patrick Daniel Maguire, Ann Arbor, MI (US)

(21) Appl. No.: 18/805,829

(22) Filed: Aug. 15, 2024

Related U.S. Application Data
(60) Provisional application No. 63/607,888, filed on Dec. 8, 2023.

(51) Int. Cl. H01M 50/516; B23K 31/02; H01M 50/557

(52) U.S. Cl. CPC H01M 50/516; B23K 31/02; H01M 50/557; H01M 2220/20

(57) ABSTRACT

A method of assembling a battery pack includes inserting a guide within a slot of a slotted assembly; guiding one or more terminals into the slot using the guide; and withdrawing the guide from the slot while the one or more terminals remain in the slot. A traction battery pack assembly includes a terminal guide; and an actuator assembly that rotates the terminal guide back and forth between a guiding position and a withdrawn position. The terminal guide is at least partially disposed within a slot of a slotted assembly when in the guiding position such that the terminal guide can guide insertion of one or more terminals into the slot. The terminal guide is withdrawn from the slot when in the withdrawn position.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure relates generally to positioning tab terminals when assembling of a traction battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a method of assembling a battery pack, including: inserting a guide within a slot of a slotted assembly; guiding one or more terminals into the slot using the guide; and withdrawing the guide from the slot while the one or more terminals remain in the slot.

In some aspects, the techniques described herein relate to a method, wherein the guide is funnel-shaped during the guiding.

In some aspects, the techniques described herein relate to a method, wherein the guide funnels the one or more terminals into the slot.

In some aspects, the techniques described herein relate to a method, wherein the guide is rotated to insert the guide into the slot and rotated to withdraw the guide from the slot.

In some aspects, the techniques described herein relate to a method, wherein the guide includes a first arced member and a second arced member.

In some aspects, the techniques described herein relate to a method, further including, after the withdrawing, folding the one or more terminals over a busbar of the slotted assembly.

In some aspects, the techniques described herein relate to a method, further including, after the folding, welding the one or more terminals to the busbar.

In some aspects, the techniques described herein relate to a method, wherein the one or more terminals are one or more terminals of pouch-style battery cells.

In some aspects, the techniques described herein relate to a method of assembling a battery pack, including: funneling one or more terminals through a guide assembly into a slot of a slotted assembly such that the one or more terminals extend from a first side of the slotted assembly to an opposite second side of the slotted assembly; and securing the one or more terminals to a busbar of the slotted assembly.

In some aspects, the techniques described herein relate to a method, wherein the guide assembly includes a first arced member and a second arced member.

In some aspects, the techniques described herein relate to a method, wherein the first arced member and the second arced member are rotated through the slot prior to the funneling, and are rotated out of the slot after the funneling and prior to the securing.

In some aspects, the techniques described herein relate to a method, wherein the first arced member and the second arced member are rotated in opposite directions when the first arced member and the second arced member are rotated through the slot, wherein the first arced member and the second arced member are rotated in opposite directions when the first arced member and the second arced member are rotated out of the slot.

In some aspects, the techniques described herein relate to a method, wherein the guide assembly is within the slot during the funneling, and is withdrawn from the slot during the securing.

In some aspects, the techniques described herein relate to a method, wherein the guide assembly is rotated into the slot and is rotated out of the slot.

In some aspects, the techniques described herein relate to a traction battery pack assembly, wherein the terminal guide includes a first arced member and a second arced member.

In some aspects, the techniques described herein relate to a traction battery pack assembly, wherein the actuator assembly rotates the terminal guide back and forth between the guiding position and the withdrawn position.

In some aspects, the techniques described herein relate to a traction battery pack assembly, wherein the slotted assembly includes a plurality of busbars.

In some aspects, the techniques described herein relate to a traction battery pack assembly, wherein the terminal guide is configured to funnel the one or more terminals into the slot when the terminal guide is in the guiding position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a perspective view of a battery cell from the battery pack of FIG. 2.

FIG. 4 illustrates a close-up view of an area of FIG. 2 showing a slotted assembly and tab terminals of battery cells secured to busbars of the slotted assembly.

FIGS. 5-11 show the area of FIG. 4 at selected steps of an assembly process for securing terminals to busbars of one of the slotted assemblies.

### DETAILED DESCRIPTION

This disclosure details example assembly methods and assembly aids that can be used to facilitate positioning terminals of a traction battery pack within slots of a slotted assembly. After positioning the terminals within the slots, the terminals can be secured to busbars of the slotted assembly.

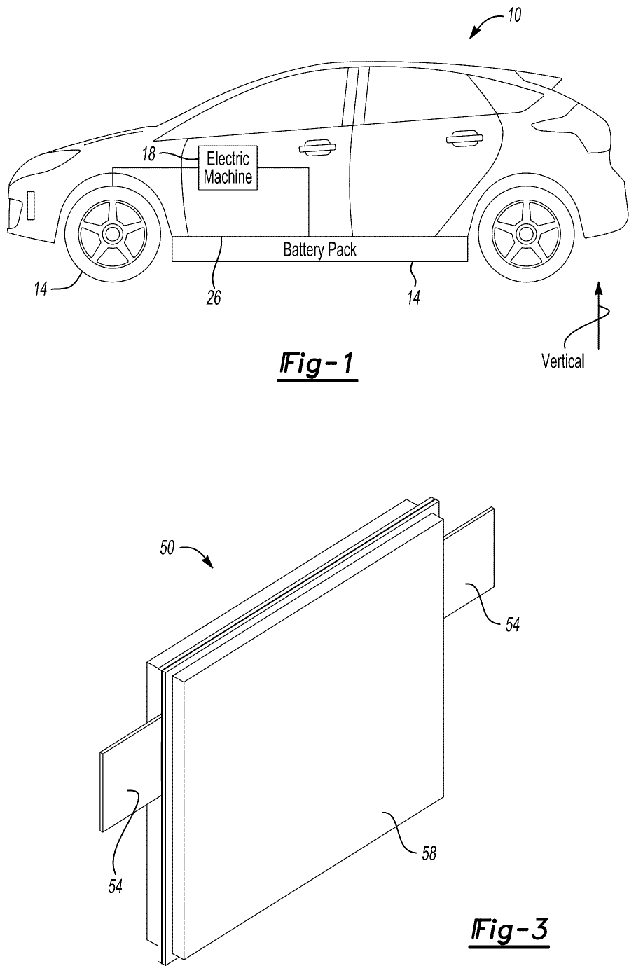

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

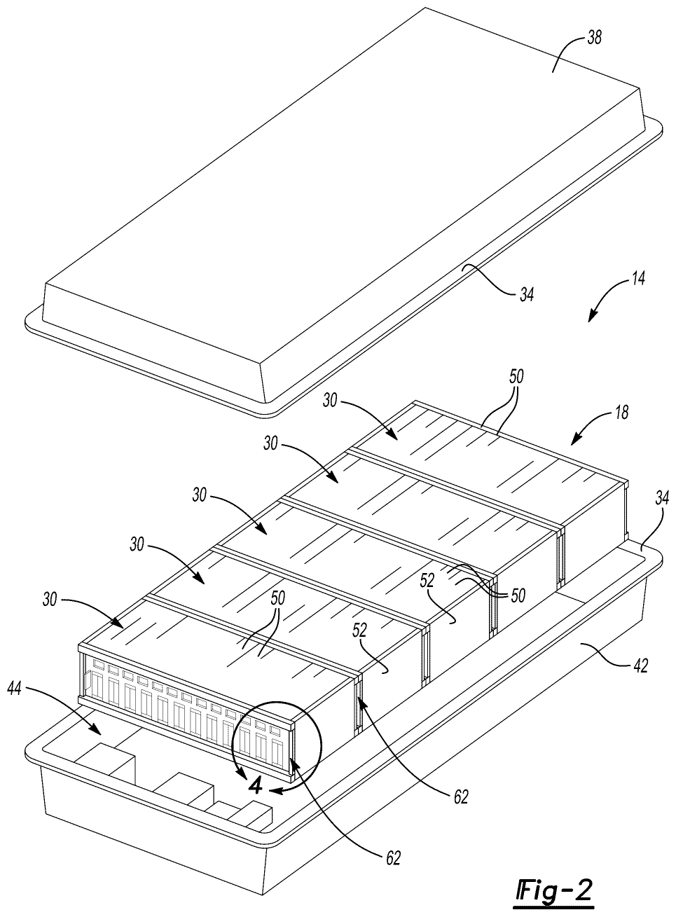

With reference now to FIGS. 2 to 4, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) stacked side-by-side relative to each along a respective cell stack axis. The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

With the cell stacks 30, the individual battery cells 50 can be electrically connected together. The cell stacks 30 can also be connected to each other. To facilitate these electrical connections, the battery cells 50 each include a pair of tab terminals 54 extending from a case 58. The tab terminals 54 of the battery cells 50 can be connected to the tab terminals 54 of other battery cells 50 and to other structures.

In this example, alongside the battery cells 50 are slotted assemblies 62. Each cell stack 30 is positioned between two slotted assemblies 62 in this example. The example slotted assemblies 62 each include a frame 66, a first beam 70, a second beam 74, and a plurality of busbars 78. The slotted assemblies 62 can be considered cross-member assemblies in some examples.

In the exemplary embodiment, the busbars 78 are heat-staked to the frame 66, which is a polymer-based material. The frame 66 could be injection molded. The frame 66, the first beam 70, and the second beam 74 extend longitudinally a length of the cell stack 30. The first beam 70 and the second beam 74 are pultruded beams in this example. The first beam 70 and the second beam 74 can be adhesively secured to the frame 66.

When the cell stacks 30 are assembled, the tab terminals 54 extend through a plurality of slots 82 in the frame 66. The tab terminals 54 are folded over the busbars 78 and attached to the busbars 78 via welds, for example.

The tab terminals 54 are typically thin strips of foil. The tab terminals 54 can be, for example, copper foil or aluminum foil.

Exemplary embodiments of this disclosure utilize a guide to help position the tab terminals 54 within the slots 82 in the frame 66 during assembly.

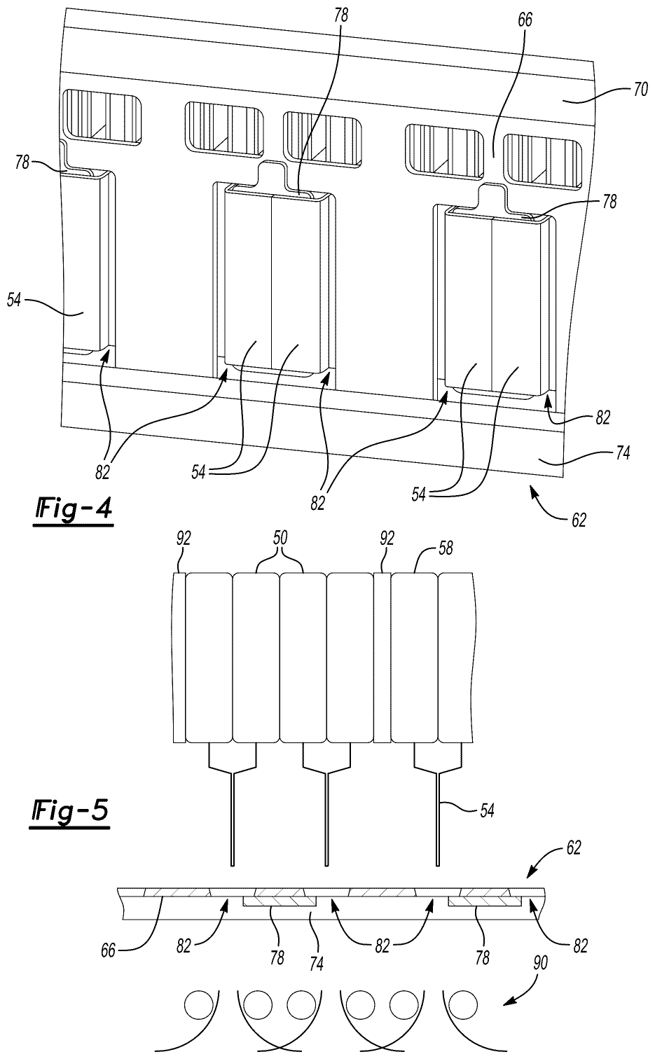

With reference to FIG. 5 and continuing reference to FIG. 4, in an exemplary embodiment, the slotted assembly 62 is positioned between battery cells 50 and a guide 90 during assembly. The slotted assembly 62 is positioned such that the tips of the tab terminals 54 are generally aligned with the slots 82 within the frame 66 of the slotted assembly 62.

Tab terminals 54 of the battery cells 50 can be stamped in the configuration shown. Dividers 92 can be positioned between the battery cells 50.

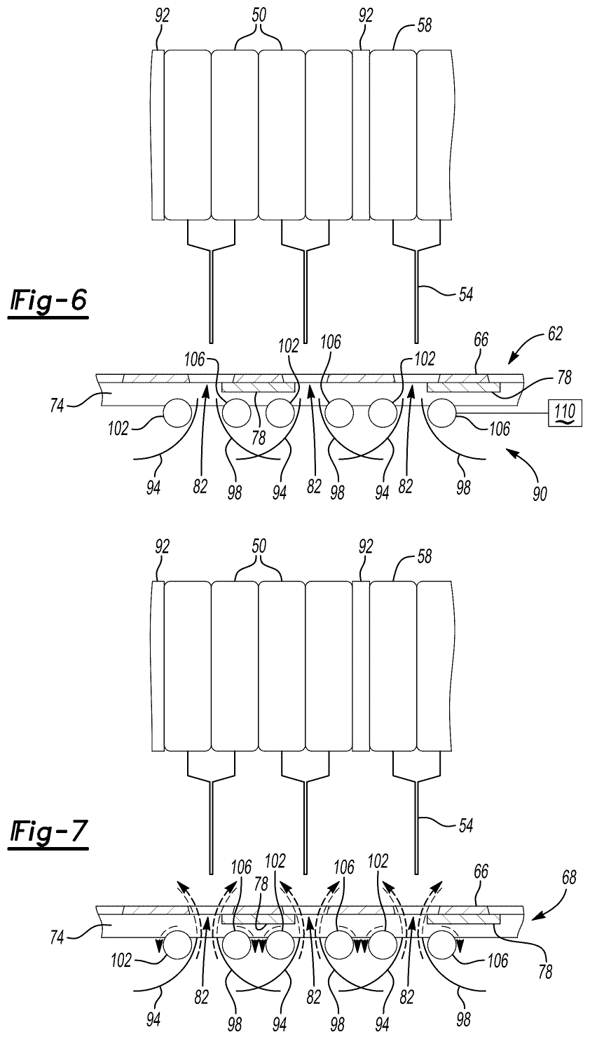

Next, with reference to FIG. 6, the guide 90 is moved closer to the slotted assembly 62. The guide 90, in the exemplary embodiment, includes pairs of first arced members 94 and second arced members 98. The guide 90 additionally includes an actuator system having first rollers 102 associated with each of the first arced members 94, second rollers 106 associated with each of the second arced members 98 and an actuator assembly 110 that can rotate the first rollers 102 and the second rollers 106. The actuator assembly 110, which is schematically shown, can be an electric motor, for example. The first arced members 94, the second arced members 98, the first rollers 102, and the second rollers 106 can be a synthetic polymer, such as acetal.

The first rollers 102 can include teeth that mesh with teeth of the first arced members 94 such that rotation of the first rollers 102 moves the first arced members 94. Similarly, the second rollers 106 can include teeth that mesh with a plurality of corresponding teeth of the second arced members 98 such that rotation of the second rollers 106 moves the second arced members 98.

In another example, the actuator system could include lever arms that can move the pairs of first arced members 94 and second arced members 98. The lever arms could be used instead of the first rollers 102 and the second rollers 106. The first arced members 94 and the second arced members 98 could be rotated into the slots 82 by respective lever arms. The lever arms, instead of the first rollers 102 and second rollers 106 can allow for linear actuators (with linear translation movement) to move the pairs of first arced members 94 and second arced members 98 into the slots 82 rather than the rotatory actuation (with gears and teeth) provided by the exemplary first rollers 102 and second rollers 106. In some examples, the lever arms could be less complex than the actuator system incorporating the first rollers 102 and the second rollers 106.

After the guide 90 is moved into the position of FIG. 6, the actuator assembly 110 is powered to drive rotation of the first rollers 102 and the second rollers 106. As shown in FIG. 7, this causes pairs of the first arced members 94 and the second arced members 98 to rotate into corresponding slots 82 of the slotted assembly 62 thereby inserting the guide 90 into the slots 82. The first rollers 102 and the second rollers 106 rotate in opposite directions to drive the pairs of the first arced members 94 and the second arced members 98 through the slots 82.

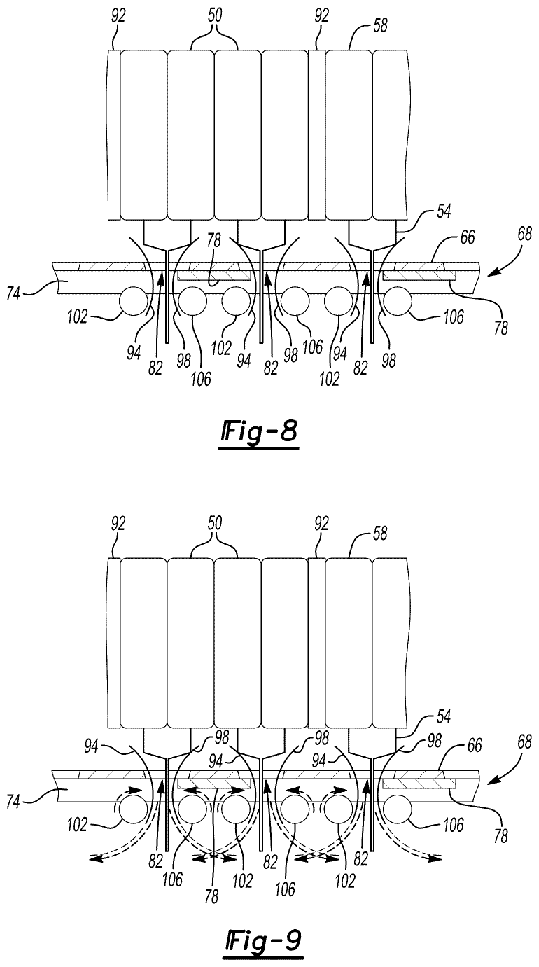

After sufficient rotation, the first arced members 94 and the second arced members 98 provide a funnel-shaped receptacle as shown in FIG. 8. The tab terminals 54 are then moved relatively to the guide 90 and the slotted assembly 62 between the pairs of the first arced members 94 and the second arced members 98. The funnel-shapes provided by the pairs of first arced members 94 and second arced members 98 helps to guide the tab terminals 54 into the slots 82 of the slotted assembly 62.

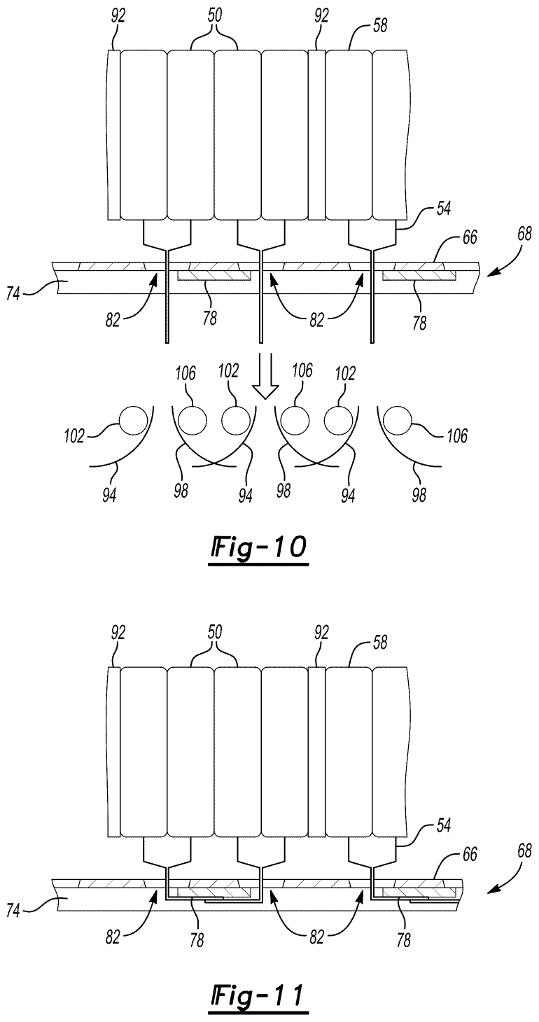

Next, as shown in FIG. 9, the rotation of the first rollers 102 and the second rollers 106 can be reversed to withdraw the first arced members 94 and the second arced members 98 from within the slots 82. The tab terminals 54 remain in the slots after the first arced members 94 and the second arced members 98 are withdrawn. The guide 90 can then be moved relatively away from the slotted assembly 62 as shown in FIG. 10.

Next, as shown in FIG. 11, the tab terminals 54 can be folded over respective busbars 78 and secured to the respective busbars 78 via welds, for example.

While the first arced members 94 and the second arced members 98 are have an arced or curved profile in this example, other example guides could have members that are not arced or curved, and are moved through slots to help direct terminals into the slots. That is, the guide 90 could uses a straight, rather than arced, guides.

Features of the some of the examples of this disclosure include utilizing a guide to assist in positioning terminals within a slot of a slotted assembly. The guide can assist positioning the tab terminals by funneling the tab terminals into the slot. After the terminals are positioned within the slot, the guide can be withdrawn.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method of assembling a battery pack, comprising:
inserting a guide within a slot of a slotted assembly;
guiding one or more terminals into the slot using the guide; and
withdrawing the guide from the slot while the one or more terminals remain in the slot.

2. The method of claim 1, wherein the guide is funnel-shaped during the guiding.

3. The method of claim 1, wherein the guide funnels the one or more terminals into the slot.

4. The method of claim 1, wherein the guide is rotated to insert the guide into the slot and rotated to withdraw the guide from the slot.

5. The method of claim 1, wherein the guide includes a first arced member and a second arced member.

6. The method of claim 1, further comprising, after the withdrawing, folding the one or more terminals over a busbar of the slotted assembly.

7. The method of claim 6, further comprising, after the folding, welding the one or more terminals to the busbar.

8. The method of claim 1, wherein the one or more terminals are one or more terminals of pouch-style battery cells.

9. A method of assembling a battery pack, comprising:
funneling one or more terminals through a guide assembly into a slot of a slotted assembly such that the one or more terminals extend from a first side of the slotted assembly to an opposite second side of the slotted assembly; and
securing the one or more terminals to a busbar of the slotted assembly.

10. The method of claim 9, wherein the guide assembly includes a first arced member and a second arced member.

11. The method of claim 10, wherein the first arced member and the second arced member are rotated through the slot prior to the funneling, and are rotated out of the slot after the funneling and prior to the securing.

12. The method of claim 10, wherein the first arced member and the second arced member are rotated in opposite directions when the first arced member and the second arced member are rotated through the slot, wherein the first arced member and the second arced member are rotated in opposite directions when the first arced member and the second arced member are rotated out of the slot.

13. The method of claim 9, wherein the guide assembly is within the slot during the funneling, and is withdrawn from the slot during the securing.

14. The method of claim 13, wherein the guide assembly is rotated into the slot and is rotated out of the slot.

15. A traction battery pack assembly, comprising:
a terminal guide; and
an actuator assembly that rotates the terminal guide back and forth between a guiding position and a withdrawn position, the terminal guide at least partially disposed within a slot of a slotted assembly when in the guiding position such that the terminal guide can guide insertion of one or more terminals into the slot, the terminal guide withdrawn from the slot when in the withdrawn position.

16. The traction battery pack assembly of claim 15, wherein the terminal guide includes a first arced member and a second arced member.

17. The traction battery pack assembly of claim 15, wherein the actuator assembly rotates the terminal guide back and forth between the guiding position and the withdrawn position.

18. The traction battery pack assembly of claim 15, wherein the slotted assembly includes a plurality of busbars.

19. The traction battery pack assembly of claim 15, wherein the terminal guide is configured to funnel the one or more terminals into the slot when the terminal guide is in the guiding position.
